(19) United States
(12) Patent Application Publication
(10) Pub. No.: US 2022/0017792 A1
(43) Pub. Date: Jan. 20, 2022

(54) FOAM MASKING TAPE INSTALLER, FOAM MASKING TAPES, AND METHODS OF INSTALLING THE SAME USING THE INSTALLER

(71) Applicant: William B. Twitty, Ridgeland, SC (US)

(72) Inventor: William B. Twitty, Ridgeland, SC (US)

(21) Appl. No.: 17/380,166

(22) Filed: Jul. 20, 2021

Related U.S. Application Data
(60) Provisional application No. 63/053,846, filed on Jul. 20, 2020.

(51) Int. Cl. C09J 7/40; B05B 12/20; C09J 7/26; C09J 7/20; C09J 7/38; C09J 5/00

(52) U.S. Cl. CPC C09J 7/403; B05B 12/20; C09J 7/26; C09J 7/203; C09J 7/405; C09J 2400/28; C09J 5/00; C09J 2203/31; C09J 2203/354; C09J 2400/243; C09J 7/38

(57) ABSTRACT

Installers for elongate foam masking tape have an elongate body that has a spine opposite a fore edge, which are separated from one another by opposing exterior surfaces, and has a material that prevents adhesion of an adhesive on each of the opposing exterior surfaces at a position adjacent to the fore edge and extending the length of the elongate body. The installers are used to insert tubular foam masking tape in the gap between body panels of an automobile vehicle, for example, and to adhere the tubular foaming masking tape to the rear surface of the body panels prior to application of paint thereto. Methods of installing tubular foam masking tape between body panels using the installer are disclosed as well.

### RELATED APPLICATIONS

This application claims the benefit of U.S. Provisional Application No. 63/053,846, filed Jul. 20, 2020, the entirety of which is incorporated herein by reference.

### TECHNICAL FIELD

This application relates to a foam masking tape installer, foam masking tapes, and methods of installing foam masking tapes using the foam masking tape installer, more particularly, a foam masking tape installer having an elongate body with a spine opposite a fore edge and opposing exterior surfaces adjacent to the fore edge have a material that prevents adhesion of an adhesive extending the length of the body.

### BACKGROUND

During the automotive paint refinishing process, all edges of an automotive panel, which are typically metal, require masking for overspray prevention. This masking process requires accessibility to the backside of the panels to attach foam or regular masking tape. Some panels are not accessible from the backside, thereby resulting in a butt joint with a gap and no way to apply tape to the backside to properly seal the same, e.g., between a door edge and a fender panel. Two common methods to mask automotive panels include: (1) application of traditional masking tape and/or masking paper while a door is open, and (2) application of foam masking tape, such as 3M™ Soft Edge Foam Masking Tape or 3M™ Soft Edge Foam Masking Tape Plus while a door is open. According to a video by the Minnesota Mining and Manufacturing Company, masking an open card door with one of the company's foam masking tapes can be accomplished in about 2.5 minutes as compared to masking with regular masking tape, which can be accomplished in about 8 minutes.

While the application of the foam masking tape is an improvement in application time relative to traditional masking tapes, there is still need for improvement. As noted above, there is a need to properly sealing the butt joints, even using the foam masking tapes, more quickly and effectively, especially without opening a door of the automotive vehicle.

### SUMMARY

In all aspects, installers for an elongate foam masking tape are disclosed that have an elongate body having a spine opposite a fore edge which are separated from one another by opposing exterior surfaces, which each have, at a position adjacent to the fore edge and extending the length of the elongate body, a material that prevents adhesion of an adhesive thereto. In one embodiment, the spine of the elongate body comprises a plurality of spaced apart notches or slits along the length of the spine. In all embodiments, the elongate body has a length in a range of 10 cm to 50 cm and a thickness measured at the fore edge is in a range of 0.5 mm to 3 mm. In one embodiment, the spine comprises an ergonomic grip for a hand of the user.

In all aspects, the material that prevents adhesion can be a release liner permanently affixed to the elongate body. The elongate body may be made of pressed paperboard, plastic, or a combination thereof. In one embodiment, the elongate body comprises pressed paperboard having a thickness of 0.0.22 inches to 0.120 inches.

In one embodiment, the fore edge has an adhesive layer applied thereto.

In another aspect, methods of masking automotive panels against overspray is disclosed. The methods include providing juxtaposed body panels having a distance of separation therebetween that defines a gap, providing an installer described herein, adhesively attaching a strip of elongate foam masking tape to the fore edge of the installer, applying a pushing force to the installer to push the strip of elongate foam masking tape into one of the gaps between the body panels and past a rear surface of each body panel, and applying a pulling force to the installer to adhere the elongate strip of foam masking tape to the rear surface of each body panel and remove the installer from the elongate strip of foam masking tape. The width of the elongate foam masking tape is typically greater than a width of one of the gaps between body panels. In one embodiment, one of the body panels is a closed door.

Adhesively attaching includes positioning an adhesive layer of the strip of elongate foam masking tape on the fore edge with the fore edge proximate a central longitudinal line of the adhesive layer. The foam masking tape is typically tubularly shaped.

In one embodiment, the fore edge of the installer comprises an adhesive layer, and the elongate foam masking tape has an installer facing surface comprising parallel spaced apart adhesive layers defining a gap therebetween to receive the fore edge of the installer. In any and all embodiment, the elongate foam masking tape may have a profile opposite the installer facing surface that converges in a direction away from the installer, and the installer facing surface may define a trough between the parallel spaced apart adhesive layers.

In another aspect, foam masking tapes are disclosed for use with any of the installers described herein. The foam masking tapes have an elongate foam body having an installer facing surface comprising parallel spaced apart adhesive layers defining a gap therebetween to receive the installer. The installer facing surface may define a trough between the parallel spaced apart adhesive layers. The elongate foam body can have a profile opposite the installer facing surface that converges in a direction away from the installer. In some embodiments, in a transverse cross-section, the elongate foam body is generally heart-shaped or generally triangularly-shaped. In all embodiments, the adhesive layer comprises a pressure sensitive adhesive having a coloring agent or pigment therein.

In another embodiment, the foam masking tape has an elongate foam body having an installer facing surface that defines a trough extending the length of the elongate foam body and has a continuous adhesive layer within the trough and extending beyond the trough on the installer facing surface along opposing elongate sides of the trough. In one embodiment, the adhesive layer comprises a pressure sensitive adhesive having a coloring agent or pigment therein.

### BRIEF DESCRIPTION OF THE DRAWINGS

FIG. 1 is a photograph of an automotive vehicle with an installer of foam masking tape with the foam masking tape attached and partially inserted in a gap between body panels.

FIG. 2 is a front perspective view of the installer.

FIG. 3 is a side view of the installer with an elongate piece of foam masking tape in the process of being adhered thereto.

FIG. 4 is an end view of the installer with an elongate piece of foam masking tape adhered prior to installation between body panels.

FIG. 5 is an end view of the installer with an elongate piece of foam masking tape compressed against the opposing exterior surfaces of the installer in simulation of its compression when passing between the body panels.

FIG. 6 is a photograph of a second embodiment of an installer with an elongate piece of foam masking tape adhered thereto.

FIG. 7 is a schematic illustrated flowchart of the installation of the foam masking tape using the installer.

FIG. 8 is a photograph of an installer with an elongate piece of foam masking tape adhered thereto with the boundary of the adhesive layer accentuated with a marker line.

FIG. 9 is an end view of a third embodiment of an installer.

FIG. 10 is an illustration a new embodiment for a foam masking tape compatible with the installer of FIG. 9.

FIG. 11 is an illustration of a second new embodiment for a foam masking tape compatible with the installer of FIG. 9.

FIG. 12 is a modification of the foam masking tape of FIG. 10 to have a continuous adhesive layer.

### DETAILED DESCRIPTION

The following description and drawings are illustrative and are not to be construed as limiting. In the drawings, like reference numbers indicate identical or functionally similar elements. Numerous specific details are described to provide a thorough understanding of the disclosure. In certain instances, however, well-known or conventional details are not described to avoid obscuring the description. References to one or an embodiment in the present disclosure can be, but are not necessarily, references to the same embodiment, and such references mean at least one of the embodiments.

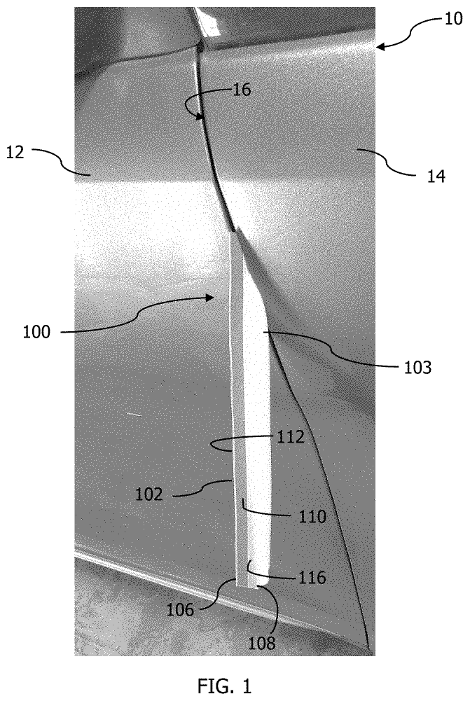

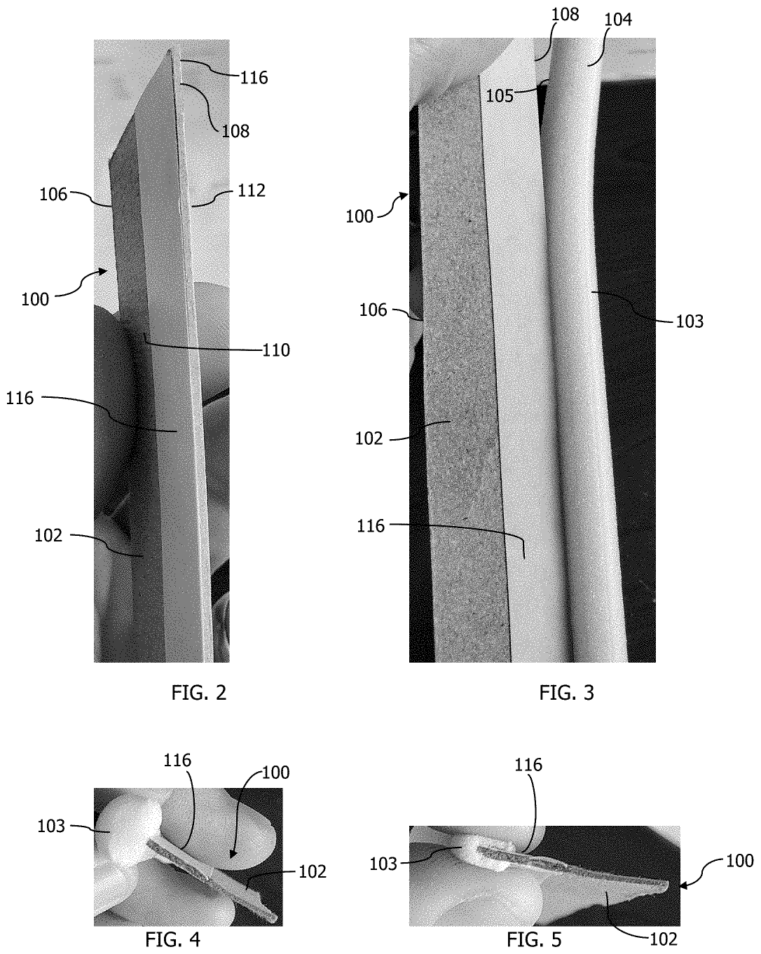

Referring to FIGS. 1-6 and 8, a tape installer 100 for an elongate foam masking tape 103, such as 3M™ Soft Edge Foam Masking Tape, 3M™ Soft Edge Foam Masking Tape Plus, or any competitive equivalent, is shown in photographs of multiple views. Such foam masking tapes 103 are generally tubularly shaped, thereby having a generally tubular elongate foam body 104 and an adhesive layer 105 applied to less than 180 degrees of the exterior surface, labeled in FIGS. 3, 7, and 8. In FIG. 1, the tape installer 100 having a strip of a foam masking tape 103 adhered thereto is shown partially inserted into the gap 16 between a front door 12 and front fender panel 14 of an automobile 10. The foam masking tape within the gap 16 is in a compressed state and the portion yet to be inserted is in an uncompressed state. While body panels of an automobile are used herein as an example, the invention is not limited thereto. Any device to be painted that has adjacent panels separated by a gap, i.e., having a distance of separation, is applicable.

The tape installer 100 has an elongate body 102, which can be referred to as a ribbon, having a spine 106 opposite a fore edge 108, which are separated from one another by opposing exterior surfaces 110, 112. In FIG. 1, the opposing exterior surface 110 that is visible is a right exterior surface relative to a user facing the vehicle and the other exterior surface 112 that is not visible is a left exterior surface. The full length of each of the right exterior surface 110 and the left exterior surface 112 at a position adjacent to the fore edge 108 are covered with, coated with, or made of a material that prevents adhesion of an adhesive 116 thereto, i.e., the adhesive of the adhesive layer of the foam masking tape.

The elongate body 102 has a length in a range of 10 cm to 50 cm, more preferably 15 cm to 30 cm. The thickness of the elongate body measured at the fore edge is smaller than the width of the gap between body panels 12, 14 and can be in a range of 0.5 mm to 3 mm.

The elongate body 102 is made of flexible material that has a stiffness sufficient to push the foam masking tape in a gap defined between adjacent body panels and can bend to follow the curvature of the body panels, if present. The flexibility of the elongate body 102 may be a physical property of the material from which the elongate body is made or the thin nature of the elongate body 102 can contribute the necessary flexibility to the installer 100. In another embodiment, as shown in FIG. 6, the flexibility of the elongate body may be from a plurality of slits 120, plurality of notches 122, or combinations thereof spaced apart preselected distances along the spine 106. The slits 120, notches 122, or combinations thereof may be uniformly spaced apart over a portion of the length of the spine 106 or along the full length of the spine 106.

The elongate body 102 may be made of pressed paperboard, plastic, or any other material(s) that can provide the needed balance of flexibility and stiffness, and combinations thereof. In one embodiment, the elongate body 102 is pressed paperboard (non-corrugated cardboard), also known as chipboard, having a thickness in a range of 20 to 120 points, about 0.22 inches to about 0.12 inches. As the thickness increases, the stiffness increases, but the material is still bendable. In one embodiment, the chipboard has a thickness in a range of 32 points to 50 points, i.e., 0.32 inches to 0.05 inches.

In one embodiment, the spine 106 comprises an ergonomic grip for a hand of the user.

The material that prevents adhesion 116 comprises a release liner permanently affixed to the elongate body. The release liner typically has a substrate, called the liner, coated with a release agent that provides a pre-selected release characteristic thereto. The substrate may be a plastic film, or paper or paperboard. Suitable paper or paper board substrates include, but are not limited to, super calendared Kraft paper, glassine, clay coated Kraft paper, machine finished Kraft paper, and machines glazed paper. Suitable plastic films include, but are not limited to, biaxially oriented polyethylene terephthalate, biaxially oriented polypropylene, high density polyethylene, low density polyethylene, and polypropylene plastic resins. Any commercially available release agent is suitable. One example release agent is a silicone coating.

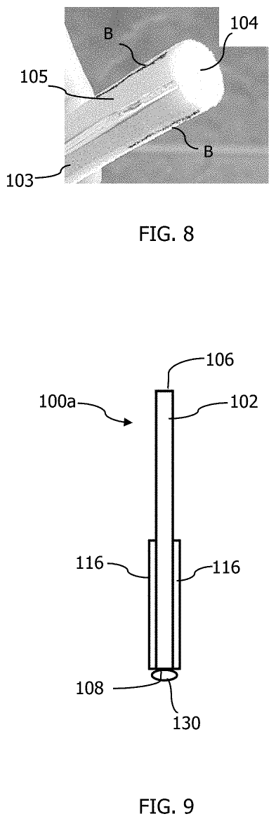

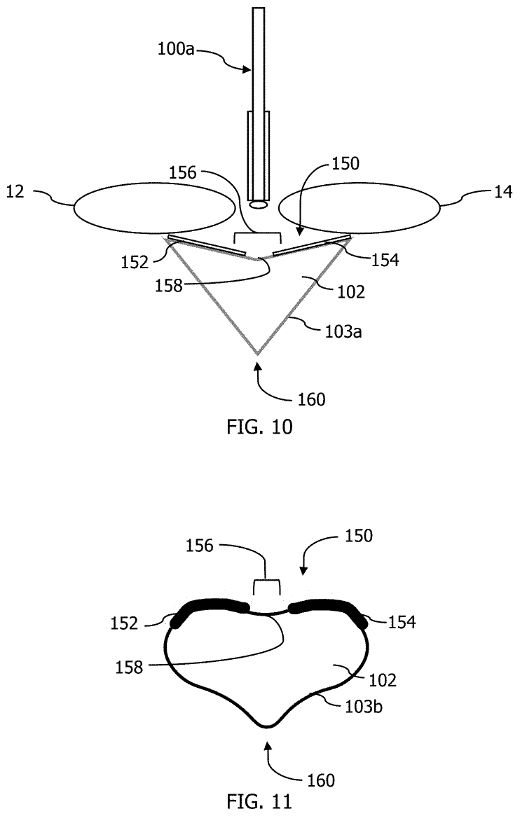

In one embodiment, as illustrated in FIGS. 9 and 10, the fore edge 108 comprises an adhesive layer 130. The adhesive layer 130 is a pressure sensitive adhesive that has greater adhesion to the fore edge 108 than to a strip of elongate foam masking tape 103. The adhesive layer 130 may be permanently affixed to the fore edge 108.

The pressure sensitive adhesive (PSA) for the adhesive layer 130 can be any commercially available or herein after developed PSA that meets the adhesive needs of the invention, i.e., has greater adhesion to the fore edge of the installer 100 than to the foam masking tape. For example, the PSA can be any variety of acrylic pressure sensitive adhesives, rubber-based pressure sensitive adhesive, and silicone pressure sensitive adhesives as disclosed in U.S. Pat. No. 7,399,527. Examples of acrylic PSAs include those that comprise as the base polymer either a homopolymer of an alkyl (meth)acrylate in which the alkyl group has 1 to 18 carbon atoms or a copolymer of the alkyl (meth)acrylate with one or more other copolymerizable monomers, e.g., functional monomers. The term “(meth)acrylate” as used herein refers to “acrylate and/or methacrylate”, and the term “(meth)acrylamide” as used herein refers to “acrylamide and/or methacrylamide”.

Examples of the alkyl (meth)acrylate include methyl acrylate, ethyl acrylate, butyl acrylate, isobutyl acrylate, hexyl acrylate, octyl acrylate, 2-ethylhexyl acrylate, isooctyl acrylate, decyl acrylate, isodecyl acrylate, lauryl acrylate, stearyl acrylate, and the alkyl methacrylates corresponding to these acrylates. Examples of the functional monomers include monomers having one or more hydroxyl groups, monomers having one or more carboxyl groups, and monomers having one or more amide groups. Examples of the monomers having one or more hydroxyl groups include hydroxyalkyl (meth)acrylates such as 2-hydroxyethyl (meth)acrylate and hydroxypropyl (meth)acrylate. Examples of the monomers having one or more carboxyl groups include α,β-unsaturated carboxylic acids such as acrylic acid, methacrylic acid, and crotonic acid; monoalkyl maleates such as butyl maleate; unsaturated dibasic acids such as maleic acid, fumaric acid, and itaconic acid; and dibasic acid anhydrides such as maleic anhydride. Examples of the monomers having one or more amide groups include acrylamide, alkyl(meth)acrylamides such as dimethyl(meth)acrylamide and diethyl(meth)acrylamide, N-alkoxymethyl(meth)acrylamides such as N-butoxymethyl(meth)acrylamide and N-ethoxymethyl(meth)acrylamide, and diacetone (meth)acryl-amide. Examples of monomers having one or more amino groups include dimethylaminoethyl (meth)acrylate. Other usable copolymerizable monomers include vinyl acetate, styrene, α-methylstyrene, vinyl chloride, acrylonitrile, ethylene, propylene, and the like.

Besides the base polymer, other ingredients such as, e.g., a tackifier and a crosslinking agent are incorporated into the PSAs as needed. Examples of the tackifier include rosin resins, polyterpene resins, coumarone-indene resins, petroleum resins, and terpene-phenol resins. Examples of the crosslinking agent include isocyanate crosslinking agents, epoxy crosslinking agents, oxazoline crosslinking agents, aziridine crosslinking agents, and metal chelate crosslinking agents.

Examples of the rubber-based PSAa include ones comprising as the base polymer a rubbery elastomer such as natural rubber, a styrene/isoprene block copolymer, a styrene/butadiene block copolymer, polyisoprene, polybutene, polyisobutylene, or an ethylene/vinyl acetate copolymer. A tackifier such as, e.g., a rosin resin, polyterpene resin, coumarone-indene resin, petroleum resin, or terpene-phenol resin is incorporated in an appropriate amount into the rubbery elastomer. For the particular application, a softener such as, e.g., liquid polybutene, mineral oil, liquid polyisoprene, or liquid polyacrylate can be incorporated.

In one embodiment, the adhesive layer 130 can be sticky layer that is washable to restore stickiness thereto. The sticky layer can be made out of silicone rubber. Silicone rubber is a material with a very low glass transition temperature and a unique cross-linking structure, which provides the silicone rubber with a sticky layer on its surface as discussed in U.S. Pat. No. 8,490,236. Any other commercially available material that is washable to restore stickiness can also be used for the adhesive layer 130.

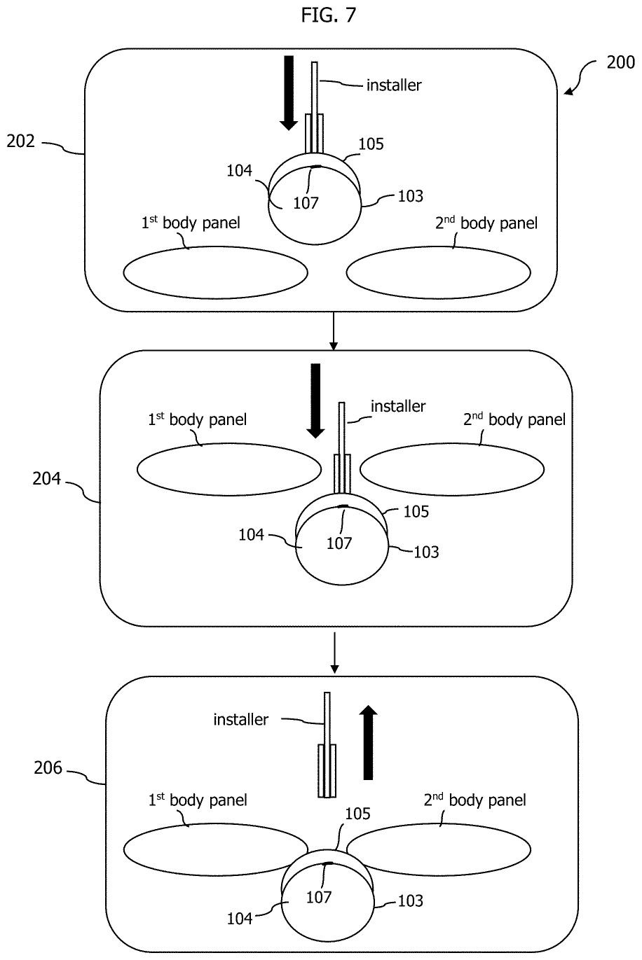

Referring now to the flow chart of FIG. 7, a method 200 of using the tape installer to insert a foam masking tape between body panels before painting the same is schematically illustrated. The body panels can include, a door (in a closed position) and a fender panel, two doors (both of which are closed), a fender to hood, or any other juxtaposed body panels that define a gap therebetween. The method includes providing juxtaposed body panels having a distance of separation defining a gap, providing an installer for an elongate foam masking tape, as described above with respect to FIGS. 1-6 and FIGS. 8-9, adhesively attaching a strip of elongate foam masking tape to the fore edge of the installer, and applying a pushing force to the installer, as indicated in box 202 and 204 by the large arrow, to push the strip of elongate foam masking tape into the gap between the body panels and past a rear surface of each body panel. Thereafter, the pushing force is changed to a pulling force, which is applied to the installer to adhere the elongate strip of foam masking tape to the rear surface of each body panel and to remove the installer from the elongate strip of foam masking tape as shown in box 206. The width of the elongate foam masking tape is greater than a width of the gap between the body panels and the width of the installer is smaller than the width of the gap between the body panels.

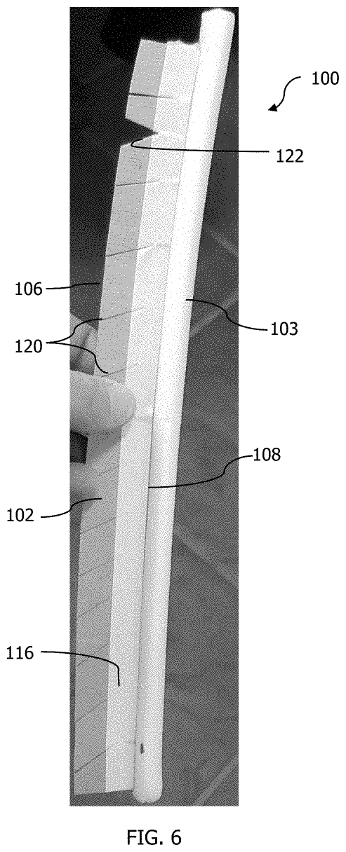

In operation, when the foam masking tape is being pushed into the gap between the body panels, the body panels will compress the foam masking tape against the release liner on opposing sides of the installer as depicted in FIG. 5. But, as shown in box 204 of FIG. 7, once the foam masking tape has passed through the gap, the foam masking tape regains its uncompressed form and its adhesive layer is available for adhering to the rear surface of each body panel. Then, with the application of the pulling force, the installer is pulled free from the foam masking tape and the foam masking tape is retained against the rear surface of the body panels. The adhesive layer of the foam masking tape has a greater adherence to the body panels than to the installer, thereby leaving the foam tape in place as desired and rendering the installer available for application of another strip of foam masking tape.

After the paint application process is complete, the foam tape is removed by stretching to release the adhesive. This is most easily accomplished by opening the door of the vehicle to reach the foam tape or by reaching under the vehicle between panels.

The advantages of the methods disclosed herein include faster installation time for the foam masking tape, which improves productivity, and more accurate placement of the foam masking tape against the rear surface of each body panel.

Adhesively attaching the foam masking tape to the installer may be accomplished by either using the adhesive layer on the foam masking tape itself or by having an adhesive layer on the fore edge of the installer as shown in FIG. 9. When the adhesive layer is part of the foam masking tape, the method includes positioning the adhesive layer of the strip of foam masking tape on the fore edge of the installer with the fore edge proximate a central longitudinal line of the adhesive layer. This is illustrated in the photograph of FIG. 8. In FIG. 8, the longitudinal boundaries of the adhesive layer on the foam masking tape running the length of the foam masking tape have been marked by a marker and the fore edge of the installer is positioned centered between the boundaries.

When the adhesive layer is part of the fore edge of the installer, the method includes adhering the foam masking tape to the adhesive layer of the fore edge. In this embodiment, a new foam masking tape configuration is appropriate. Here, as shown in FIGS. 10 and 11, the elongate foam masking tapes 103a, 103b have an installer facing surface 150 upon which parallel spaced apart adhesive layers 152, 154 extend the length of foam masking tape and are spaced apart a preselected distance to define a gap 156 to receive the fore edge of the installer. The gap 156 of the installer facing surface 150 of each foam masking tape 103a, 103b can be shaped as a trough 158. The elongate foam masking tape has a profile 160, as viewed in a transverse cross-section as shown in FIGS. 10 and 11, opposite the installer facing surface 150 that converges in a direction moving away from the installer and from the installer facing surface 150.

As seen in FIG. 10, the elongate foam body 102, in a transverse cross-section, is generally triangularly-shaped. In other words, the back surface of the foam masking tape 103a is a triangular prism. And, as seen in FIG. 11, the elongate foam body 102, in a transverse cross-section, is generally heart-shaped. The foam tapes may be made as disclosed in U.S. Pat. Nos. 4,996,092 and 5,413,637 or using any other commercially available methods and materials already known to one of skill in the art.

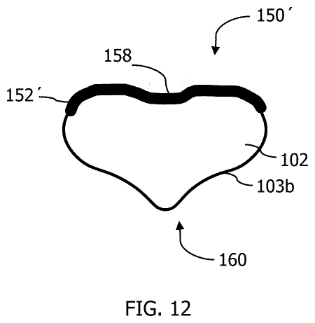

Turning now to FIG. 12, the foam tape of FIG. 11 has been modified to have a continuous layer of adhesive 152′ on the undulating installer facing surface 150′ defined by the generally heart-shaped cross-section. The tape of FIG. 10, likewise, can have a continuous layer of adhesive when the installer does not include an adhesive on the fore edge thereof. In each such embodiment, the pressure sensitive adhesive for the adhesive layer 152′ can be any of the PSA's discussed above and can include a coloring agent or pigment to render the adhesive layer visible to the user.

The advantages of the new foam masking tapes 103a, 103b include a contoured profile that render the foam masking tape easier to insert into the gap between body panels and a clearly visible gap in which to adhere the installer to the tape, which makes it easier to stay centered on an elongate strip of foam masking tape.

When the adhesive is on the foam tape, in one embodiment, the adhesive layer includes a coloring agent or pigment to make the adhesive layer more easily visible to the user. The colored adhesive layer can aide the user in direct placement of the foam tape to a vehicle or panels in need of being masked prior to paint application. Also, the colored adhesive layer can aide the user in centering the fore edge of the installer along the length of the adhesive layer. In another embodiment, the longitudinal boundaries of the adhesive layer on the foam masking tape running the entire length of the foam masking tape on opposing sides of the adhesive layer are delineated to make it more easily visible to the user. In one embodiment, the boundaries can be present in addition to a colored adhesive layer.

Referring back to FIG. 7, in yet another embodiment, the adhesive layer 105 on the foam masking tape 103 is transparent and a line 107 marking the longitudinal center of the adhesive layer 105 is present on the foam layer 104 beneath the adhesive layer, such that the user can see the line and align the fore edge of the installer therewith.

It should be noted that the embodiments are not limited in their application or use to the details of construction and arrangement of parts and steps illustrated in the drawings and description. Features of the illustrative embodiments, constructions, and variants may be implemented or incorporated in other embodiments, constructions, variants, and modifications, and may be practiced or carried out in various ways. Furthermore, unless otherwise indicated, the terms and expressions employed herein have been chosen for the purpose of describing the illustrative embodiments of the present invention for the convenience of the reader and are not for the purpose of limiting the invention.

Having described the invention in detail and by reference to various embodiments thereof, it will be apparent that modifications and variations are possible without departing from the scope of the invention which is defined in the appended claims.

What is claimed is:

1. An installer for an elongate foam masking tape comprising:
an elongate body having a spine opposite a fore edge which are separated from one another by opposing exterior surfaces,
wherein each of the opposing exterior surfaces at a position adjacent to the fore edge and extending the length of the elongate body, comprise a material that prevents adhesion of an adhesive thereto.

2. The installer of claim 1, wherein the spine of the elongate body comprises a plurality of spaced apart notches or slits along the length of the spine.

3. The installer of claim 1, wherein the elongate body has a length in a range of 10 cm to 50 cm.

4. The installer of claim 1, wherein the thickness of the elongate body measured at the fore edge is in a range of 0.5 mm to 3 mm.

5. The installer of claim 1, wherein the spine comprises an ergonomic grip for a hand of the user.

6. The installer of claim 1, wherein the material that prevents adhesion comprises a release liner permanently affixed to the elongate body.

7. The installer of claim 1, wherein the elongate body comprises pressed paperboard, plastic, or a combination thereof.

8. The installer of claim 7, wherein the elongate body comprises pressed paperboard having a thickness of 0.22 inches to 0.120 inches.

9. The installer of claim 1, wherein the fore edge comprises an adhesive layer.

10. A method of masking automotive panels against overspray, the method comprising:
providing juxtaposed body panels having a distance of separation therebetween that defines a gap;
providing an installer for an elongate foam masking tape comprising:
an elongate body having a spine opposite a fore edge which are separated from one another by opposing exterior surfaces;
wherein each of the opposing exterior surfaces, at a position adjacent to the fore edge and extending the length of the elongate body, comprise a material that prevents adhesion of an adhesive thereto;
adhesively attaching a strip of elongate foam masking tape to the fore edge of the installer, wherein a width of the elongate foam masking tape is greater than a width of one of the gaps between body panels;
applying a pushing force to the installer to push the strip of elongate foam masking tape into one of the gaps between the body panels and past a rear surface of each body panel; and
applying a pulling force to the installer to adhere the elongate strip of foam masking tape to the rear surface of each body panel and remove the installer from the elongate strip of foam masking tape.

11. The method of claim 10, wherein adhesively attaching includes positioning an adhesive layer of the strip of elongate foam masking tape on the fore edge with the fore edge proximate a central longitudinal line of the adhesive layer.

12. The method of claim 10, wherein the foam masking tape is tubularly shaped.

13. The method of claim 10, wherein one of the body panels is a closed door.

14. The method of claim 10, wherein the fore edge of the installer comprises an adhesive layer.

15. The method of claim 14, wherein the elongate foam masking tape has an installer facing surface comprising parallel spaced apart adhesive layers defining a gap therebetween to receive the fore edge of the installer.

16. The method of claim 15, wherein the elongate foam masking tape has a profile opposite the installer facing surface that converges in a direction away from the installer.

17. The method of claim 15, wherein the installer facing surface defines a trough between the parallel spaced apart adhesive layers.

18. The method of claim 15, wherein the elongate foam masking tape has a profile opposite the installer facing surface that converges in a direction away from the installer.

19. The method of claim 13, wherein the body panels are part of an automobile.

20-26. (canceled)
